(19) United States
(12) Patent Application Publication
(10) Pub. No.: US 2004/0190440 A1
(43) Pub. Date: Sep. 30, 2004

(54) Multiple transmission/reception orthogonal frequency division multiplexing systems and methods

(76) Inventors: Dong-kyu Kim, Kyungki-do (KR); Hoon-soon Choi, Seoul (KR)

Correspondence Address: Mitchell S. Bigel, Myers Bigel Sibley & Sajovec, P.A., P.O. BOX 37428, Raleigh, NC, 27627, US

(21) Appl. No.: 10/756,583

(22) Filed: Jan. 13, 2004

(30) Foreign Application Priority Data
Feb. 28, 2003 (KR) 10-2003-0012811

(51) Int. Cl. H04L 5/04

(52) U.S. Cl. 370/210; 370/204

(57) ABSTRACT

Orthogonal frequency division multiplexing (OFDM) transmitting and receiving apparatus and methods can extend a communication distance by duplicated transmission of symbols in multiple channels. An input OFDM data bitstream is encoded to generate a symbol stream. The symbol stream is copied into multiple symbol streams and converted into data complex symbol streams by a modulation method. An input pilot bitstream is converted into a pilot complex symbol stream, and the pilot complex symbol stream is inserted into the data complex symbol streams to generate transmission symbol streams. Fast Fourier transform (FFT) processing of the transmission symbol streams is performed. Guard intervals (GIs) are inserted into the FFT processed signals. The signals are converted into analog signals, loaded onto carriers and transmitted.

### RELATED APPLICATION

This application claims the benefit of Korean Patent Application No. 10-2003-0012811, filed Feb. 28, 2003, the disclosure of which is hereby incorporated herein by reference in its entirety as if set forth fully herein.

### FIELD OF THE INVENTION

The present invention relates to communication systems and methods, and more particular to Orthogonal Frequency Division Multiplexing (OFDM) transmitting and receiving systems and methods.

### BACKGROUND OF THE INVENTION

Orthogonal Frequency Division Multiplexing (OFDM) transmitting and receiving systems and methods are well known for voice and/or data communication. In general, OFDM is a spread spectrum technique that distributes data over a large number of carriers that may be spaced apart at various frequencies.

A wireless Local Area Network (LAN) system can wirelessly connect terminals and/or LANs of private or public networks and can provide convenience of information transmission and reception to users of devices such as computers and mobile terminals. In particular, an OFDM signal using a high frequency band, as defined in IEEE 801.11A, is generally transmitted and received at a maximum transmission speed of 54 Mbps through multiple carriers at a 5.4 GHz band. In addition, IEEE 802.11 also defines a variety of other signal systems, such as a direct sequence spread spectrum (DSSS) signal and a complementary code keying (CCK) signal.

Conventional operations for processing a signal in an OFDM transmitting and receiving apparatus are described in published U.S. Patent Application Nos. US 2002/0003772 and US 2002/0027875. Also, channel arrangements through channel allocation to a transmission signal in a prior art OFDM transmitting and receiving apparatus are shown in FIGS. 1 and 2.

FIGS. 1A and 1B are diagrams to explain arrangements of channels allocated to a transmission signal when one channel is used for an identical symbol in an OFDM transmitting and receiving apparatus of a prior art wireless LAN system. FIGS. 2A and 2B are diagrams to explain arrangements of channels allocated to a transmission signal when two channels are used for two symbols in an OFDM transmitting and receiving apparatus of a prior art wireless LAN system.

Referring to FIGS. 1A and 1B, when one channel is used for an identical symbol in an OFDM transmitting and receiving apparatus of the prior art wireless LAN system, a transmission signal (A) is allocated to any one channel among a plurality of channels (#a˜#a+3), which are allocated in units of tens of MHz in the 5.4 GHz band. FIG. 1A shows the transmission signal (A) allocated to channel #a, and FIG. 1B shows the transmission signal (A) allocated to channel #a+1 at a later point in time and/or in another configuration. In the OFDM standard, 54 MHz is the maximum to be allocated to one channel and one channel comprises a plurality of subchannels obtained by dividing the channel into frequencies in orthogonal relationships with the channel. This frequency band and subchannels of a transmission signal according to a channel number are determined by a carrier frequency and subcarrier frequencies, respectively, when a radio frequency (RF) signal is transmitted.

Referring to FIGS. 2A and 2B, when two channels are used for two symbols in an OFDM transmitting and receiving apparatus of the prior art wireless LAN system, transmission signals (A, B) are allocated to two channels, respectively, among a plurality of channels (#a˜#a+3), which are allocated in units of tens of MHz in a 5.4 GHz band. FIG. 2A shows that the transmission signals (A, B) are allocated to channels #a and #a+1, respectively, and FIG. 2B shows that the transmission signals (A, B) are allocated to channels #a+1 and #a+2 at a later point in time and/or in another configuration.

When two channels are used for transmitting two symbol signals, a fast Fourier transform (FFT) module and an inverse fast Fourier transform (IFFT) module in the transmitting and receiving apparatus may have a capacity twice as much as that of the transmitting and receiving apparatus for the allocation shown in FIGS. 1A and 1B so that an input signal can be arranged in subchannels in the two channels and signals using the two channels are generated. Transmission signals A and B are modulated with different symbols and are transmitted through different channels, respectively. As shown in FIGS. 2A and 2B, the different signals are transmitted through two channels at the same time such that the transmission rate may be twice that of a transmitting and receiving apparatus utilizing the allocation shown in FIGS. 1A and 1B.

### SUMMARY OF THE INVENTION

Some embodiments of the present invention provide OFDM transmitting and/or receiving apparatus wherein a signal-to-noise ratio (SNR) gain of the apparatus may be obtained through duplicated simultaneous transmission of identical symbols in a plurality of channels. More specifically, OFDM transmitting apparatus according to some embodiments of the present invention include a transmitter that is responsive to an input OFDM data bitstream to generate an OFDM symbol stream, and that is configured to perform FFT processing on the OFDM symbol stream and to simultaneously transmit the OFDM symbol stream that has been FFT processed over at least two OFDM channels, including OFDM subchannels thereof. Moreover, OFDM receiving apparatus according to some embodiments of the present invention comprise a receiver that is configured to simultaneously receive OFDM signals for a single OFDM data bitstream from at least two OFDM channels including OFDM subchannels thereof, and that is further configured to perform IFFT processing of the received OFDM signals from the at least two OFDM channels to generate at least two OFDM symbol streams for the single OFDM bitstream, and to process the at least two OFDM symbol streams to generate a single OFDM data bitstream.

Embodiments of the present invention also provide an OFDM transmitting and/or receiving method of a wireless LAN system, wherein a signal-to-noise ratio (SNR) gain of the apparatus may be obtained through duplicated transmission of identical symbols in a plurality of channels. In some embodiments, an OFDM transmitting method includes generating an OFDM symbol stream from an input OFDM data bitstream; performing FFT processing on the OFDM symbol stream and simultaneously transmitting the OFDM symbol stream that has been FFT processed over at least two OFDM channels including over a plurality of OFDM subchannels thereof. In other embodiments, an OFDM receiving method includes simultaneously receiving OFDM signals corresponding to a single OFDM data bitstream from at least two OFDM channels including OFDM subchannels thereof; performing IFFT processing of the received OFDM signals from the at least two OFDM channels to generate at least two OFDM symbol streams for the single OFDM bitstream, and processing the at least two OFDM symbol streams to generate the single OFDM data bitstream.

According to other embodiments of the present invention, there is provided an OFDM transmitting and receiving apparatus, for example, for a wireless LAN system, including a transmitter and receiver.

The transmitter encodes an input OFDM data bitstream to generate a symbol stream, copies the symbol stream into a plurality of symbol streams, converts the symbol streams into data complex symbol streams by a predetermined modulation method, converts an input pilot bitstream into a pilot complex symbol stream, inserts the pilot complex symbol stream into the data complex symbol streams to generate transmission symbol streams, performs fast Fourier transform (FFT) processing of each of the transmission symbol streams, inserts guard intervals (GIs) into the FFT processed signals, then converts the signals into analog signals, loads the analog signals onto carriers and transmits the signals wirelessly.

The receiver receives a radio wave, extracts an OFDM analog signal from signals in a plurality of allocated channels of the radio wave, converts the OFDM analog signals into digital signals, performs preamble processing of the digital signals to remove guard intervals, performs inverse fast Fourier transform (IFFT) processing of the signals to generate a plurality of complex symbol streams, compensates the complex symbol streams for distortion, then generates demapping symbol streams, decodes a symbol stream obtained as the average of the demapping symbol streams, and generates the decoded signal in the form of an OFDM data bitstream.

In some embodiments, the transmitter includes an encoding unit, a first formatting unit, a mapping unit, a second formatting unit, an FFT unit, a GI insertion unit, a DA conversion unit, and an RF transmission unit.

In some embodiments, the encoding unit encodes the input OFDM data bitstream and generates the symbol stream. The first formatting unit generates a plurality of copies of the symbol stream, synchronizes the symbol streams, and outputs the symbol streams. The mapping unit generates data complex symbol streams by converting the respective symbol streams output from the first formatting unit using a predetermined modulation method, and generates a pilot complex symbol stream by converting an input pilot bitstream using the predetermined modulation method. The second formatting unit generates the transmission symbol streams by inserting the pilot complex symbol stream into each of the data complex symbol streams, arranges the transmission symbol streams in respective points corresponding to the FFT processing, and outputs the transmission symbol streams. The FFT unit performs FFT processing on the transmission symbol streams output from the second formatting unit. The GI insertion unit inserts the GI into the signal output from the FFT unit and outputs the signal. The DA conversion unit converts a digital signal output from the GI insertion unit into an analog signal and outputs the signal. The radio frequency (RF) transmission unit loads the analog signal on a subcarrier and transmits it wirelessly.

In some embodiments, the receiver includes an RF reception unit, a DA conversion unit, a synchronization unit, a GI removing unit, an IFFT unit, a second deformatting unit, an equalizer unit, a demapping unit, a first deformatting unit, a combining unit, and a decoding unit.

In some embodiments, the RF reception unit receives a radio wave, extracts the OFDM analog signal from signals in a plurality of allocated channels, and outputs the OFDM signal. The digital-analog (DA) conversion unit converts the OFDM analog signal into a digital signal and outputs the signal. The synchronization unit performs preamble processing which determines the digital signal, performs synchronization and outputs the signal. The GI removing unit removes the GI from the signal output from the synchronization unit and outputs the signal. The IFFT unit performs IFFT processing on the signal output from the GI removing unit and outputs the signal. The second deformatting unit outputs the plurality of complex symbol streams corresponding to the plurality of channels, by distinguishing the symbol stream for each point output from the IFFT unit according to the plurality of channels. The equalizer unit compensates the plurality of complex symbol streams for distortion and outputs the compensated complex symbol streams. The demapping unit generates and outputs demapping symbol streams from the symbol streams output from the equalizer unit. The first deformatting unit synchronizes and outputs the demapping symbol streams. The combining unit takes the average of the demapping symbol streams output from the first deformatting unit and outputs the average as a symbol stream. The decoding unit decodes the symbol stream output from the combining unit and outputs the decoded symbol stream in the form of the OFDM data bitstream.

According to other embodiments of the present invention, there is provided an OFDM transmitting and receiving apparatus, for example, for a wireless LAN system, including a transmitter and a receiver.

In some embodiments, the transmitter encodes an input OFDM data bitstream to generate a symbol stream, converts the symbol stream into a data complex symbol stream by a predetermined modulation method, converts an input pilot bitstream into a pilot complex symbol stream, inserts the pilot complex symbol stream into the data complex symbol stream to generate a transmission symbol stream, generates a plurality of symbol stream copies from the transmission symbol stream, performs FFT processing of each of the symbol stream copies, inserts GIs into the FFT processed signals, converts the signals into analog signals, loads the analog signals onto carriers and transmits the signals wirelessly.

In some embodiments, the receiver receives a radio wave, extracts an OFDM analog signal from signals in a plurality of allocated channels of the radio wave, converts the analog signal into a digital signal, performs preamble processing of the digital signal to remove a guard interval, performs IFFT processing of the signal to generate a plurality of complex symbol streams, compensates the plurality of complex symbol streams for distortion, then takes an average to generate a demapping symbol stream, decodes the demapping symbol stream and outputs the signal in the form of the OFDM data bitstream.

In some embodiments, the transmitter includes an encoding unit, a mapping unit, a formatting unit, an FFT unit, a GI insertion unit, a DA conversion unit, and an RF transmission unit.

In some embodiments, the encoding unit encodes the input OFDM data bitstream and generates the symbol stream. The mapping unit generates a data complex symbol stream by converting the symbol stream output from the encoding unit using a predetermined modulation method and generates a pilot complex symbol stream by converting an input pilot bitstream using the predetermined modulation method. The formatting unit inserts the pilot complex symbol stream into the data complex symbol stream to generate the transmission symbol stream, generates a plurality of symbol stream copies from the transmission symbol stream, and arranges the transmission symbol streams in respective points corresponding to the FFT processing, and outputs the symbol streams. The FFT unit performs FFT processing on the symbol streams output from the formatting unit and outputs the symbol streams. The GI insertion unit inserts a GI into the signal output from the FFT unit and outputs the signal. The DA conversion unit converts the digital signal output from the GI insertion unit into an analog signal and outputs the signal. The RF transmission unit loads the analog signal on a subcarrier and wirelessly transmits the signal.

In some embodiments, the receiver includes an RF reception unit, a DA conversion unit, a synchronization unit, a GI removing unit, an IFFT unit, a deformatting unit, an equalizer unit, a combining unit, a demapping unit, and a decoding unit.

In some embodiments, the RF reception unit receives a radio wave, extracts the OFDM analog signal from signals in a plurality of allocated channels of the radio wave, and outputs the OFDM signal. The DA conversion unit converts the OFDM analog signal into a digital signal and outputs the digital signal. The synchronization unit performs preamble processing which determines the digital signal, performs synchronization and outputs the signal. The GI removing unit removes the GI from the signal output from the synchronization unit and outputs the signal. The IFFT unit performs IFFT processing on the signal output from the GI removing unit and outputs the signal. The deformatting unit outputs the plurality of complex symbol streams corresponding to the plurality of channels, by distinguishing the symbol stream for each point output from the IFFT unit according to the plurality of channels. The equalizer unit compensates each of the plurality of complex symbol streams for distortion and outputs the complex symbol stream. The combining unit takes the average of the similar complex symbol streams output from the equalizer unit, and outputs the average as a symbol stream. The demapping unit generates and outputs the demapping symbol stream from the symbol stream output from the combining unit. The decoding unit decodes the demapping symbol stream and outputs the decoded demapping symbol stream in the form of the OFDM data bitstream.

According to still other embodiments of the present invention, there are provided OFDM transmitting and receiving methods, for example, for a wireless LAN system, wherein an OFDM data bitstream is converted into a data complex symbol stream, and the data complex symbol stream is FFT processed, converted into an analog signal, and then wirelessly transmitted, and a radio wave corresponding to the wirelessly transmitted analog signal is received and an OFDM analog signal is extracted and converted into a digital signal. The signal is IFFT processed and is output in the form of an OFDM data bitstream through demapping.

In certain embodiments of OFDM transmitting methods, for example, for a wireless LAN system, first, the input OFDM data bitstream is encoded and a symbol stream is generated. Then, a plurality of copies of the symbol stream are generated, synchronized and output. Data complex symbol streams are generated by converting the plurality of symbol streams, respectively, using a predetermined modulation method, and a pilot complex symbol stream is generated by converting an input pilot bitstream using the predetermined modulation method. Transmission symbol streams are generated by inserting the pilot complex symbol stream into each of the data complex symbol stream, and arranged in respective points corresponding to the FFT processing, and output. Then, FFT processing on the symbol streams arranged in respective points corresponding to the FFT processing is performed. The GI is inserted into the FFT processed signal and the signal is output. The digital signal output, in which the GI is inserted, is converted into an analog signal and output. Then, the analog signal is loaded on a subcarrier and wirelessly transmitted.

In OFDM receiving methods, for example for a wireless LAN system according to some embodiments of the present invention, first, a radio wave is received, the OFDM analog signal is extracted from signals in a plurality of allocated channels of the received radio wave, and output. Next, the OFDM analog signal is converted into a digital signal and output. Preamble processing which determines the digital signal is performed, synchronization is performed and the signal is output. Then, the GI is removed from the synchronized signal and the signal is output. IFFT processing is performed on the signal, in which the GI is removed, and the signal is output. A plurality of complex symbol streams corresponding to the plurality of channels are output by distinguishing the IFFT processed symbol stream for each point according to the plurality of channels. Then, each of the plurality of complex symbol streams is compensated for distortion and output. Demapping symbol streams from the symbol streams which are compensated for distortion are generated and output. The demapping symbol streams are synchronized and output. The average of the demapping symbol streams, which are synchronized and output, is obtained and output. The averaged symbol stream is decoded and output in the form of the OFDM data bitstream.

In OFDM transmitting methods according to some embodiments of the present invention, first, an input OFDM data bitstream is encoded and a symbol stream is generated. Next, a data complex symbol stream is generated by converting the symbol stream using a predetermined modulation method, and a pilot complex symbol stream is generated by converting an input pilot bitstream using the predetermined modulation method. The pilot complex symbol stream is inserted into the data complex symbol stream to generate a transmission symbol stream, and a plurality of symbol stream copies of the transmission symbol stream are generated and arranged in respective points corresponding to the FFT processing, and output. FFT processing is performed on the symbol streams which are arranged in respective points corresponding to the FFT processing and the symbol streams are output. A GI is inserted into the FFT processed signal and the signal is output. The digital signal, in which the GI is inserted, is converted into an analog signal and output. The analog signal is loaded on a subcarrier and wirelessly transmitted.

OFDM receiving methods according to some embodiments of the present invention include receiving a radio wave and extracting the OFDM analog signal from signals in a plurality of allocated channels. Next, the OFDM analog signal is converted into a digital signal and output. Preamble processing that determines the digital signal is performed, synchronization is performed, and the signal is output. GI is removed from the synchronized signal and the signal is output. IFFT processing is performed on the signal, in which the GI is removed, and the signal is output. A plurality of complex symbol streams corresponding to the plurality of channels are output by distinguishing the IFFT processed symbol stream for each point according to the plurality of channels. Then, the plurality of complex symbol streams are compensated for distortion and output. The average of similar complex symbol streams that are compensated for distortion is obtained and output. The demapping symbol stream is generated from the averaged symbol stream and output. The demapping symbol stream is decoded and output in the form of the OFDM data bitstream.

### BRIEF DESCRIPTION OF THE DRAWINGS

FIGS. 1A and 1B are diagrams illustrating arrangements of channels allocated to a transmission signal when one channel is used for an identical symbol in an OFDM transmitting and receiving apparatus of a prior art wireless LAN system;

FIGS. 2A and 2B are diagrams illustrating arrangements of channels allocated to a transmission signal when two channels are used for two symbols in an OFDM transmitting and receiving apparatus of a prior art wireless LAN system;

FIGS. 3A and 3B are block diagrams of an OFDM transmitting and receiving apparatus according to embodiments of the present invention;

FIG. 4 is a diagram illustrating signal distribution by a first formatting unit of FIG. 3A;

FIGS. 5A and 5B are diagrams illustrating signal distribution by a second formatting unit of FIG. 3A;

FIG. 6 is a diagram illustrating signal combination of a combining unit of FIG. 3B;

FIGS. 7A and 7B are block diagrams of an OFDM transmitting and receiving apparatus according to other embodiments of the present invention;

FIGS. 8A and 8B are diagrams illustrating the arrangements of channels allocated to a transmission signal when two channels are used for an identical symbol in an OFDM transmitting and/or receiving apparatus according to embodiments of the present invention;

FIG. 9 is a graph showing simulation results of bit error rate (BER) values of 64 QAM mapping in an OFDM transmitting and receiving apparatus for a wireless LAN system according to embodiments of the present invention; and

FIG. 10 is a graph showing simulation results of BER values of 16 QAM mapping in an OFDM transmitting and receiving apparatus for a wireless LAN system according to embodiments of the present invention.

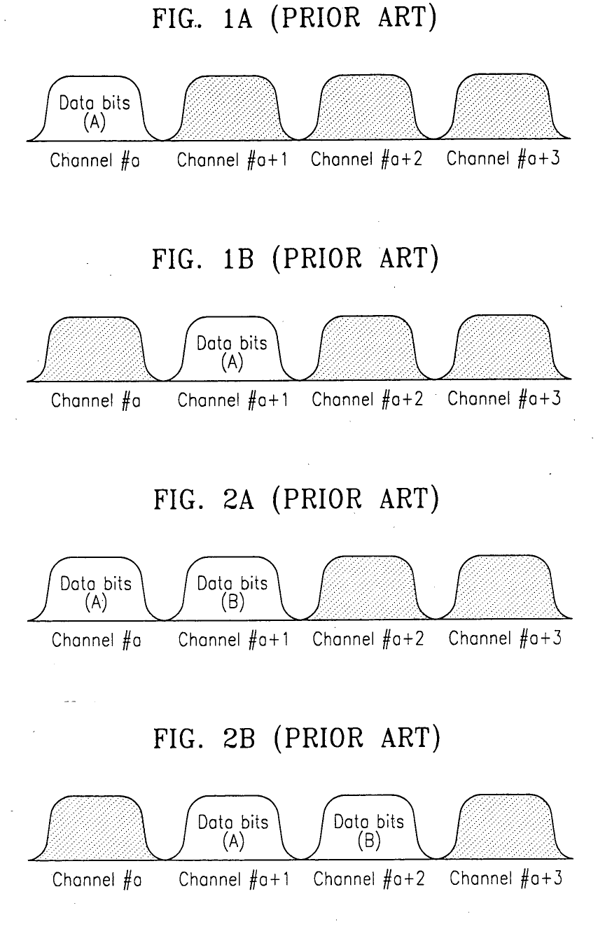

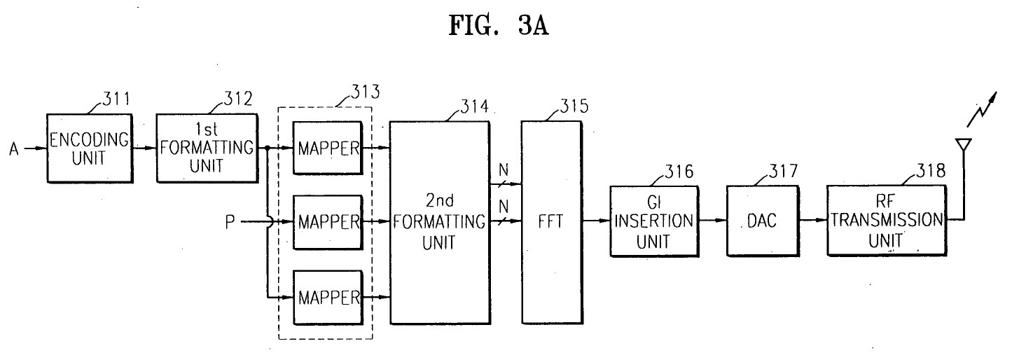

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The present invention is described below with reference to block diagrams of methods, apparatus (systems) and/or computer program products according to embodiments of the invention. It is understood that a block of the block diagrams, and combinations of blocks in the block diagrams, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagram block or blocks.

It should also be noted that in some alternate implementations, the functions/acts noted in the blocks may occur out of the order described herein. For example, two blocks shown in succession may in fact be executed substantially concurrently or the blocks may sometimes be executed in the reverse order, depending upon the functionality/acts involved.

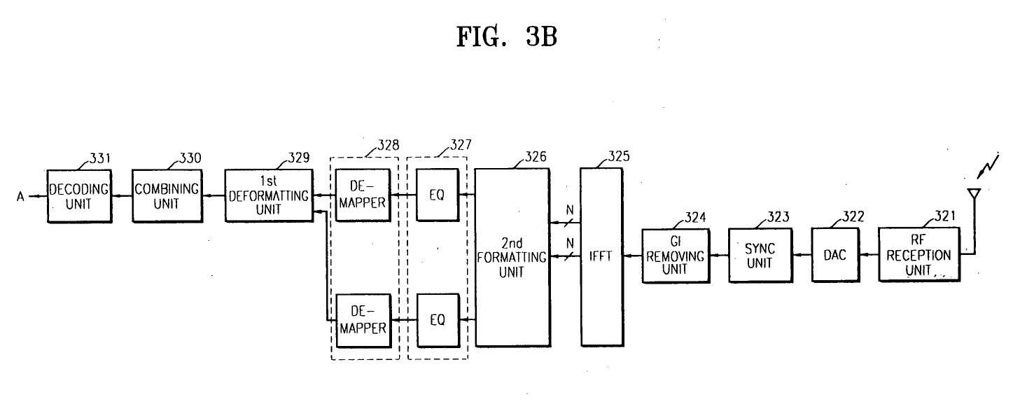

Referring to FIGS. 3A and 3B, OFDM transmitting and/or receiving apparatus according to embodiments of the present invention include a transmitter shown in FIG. 3A and/or a receiver shown in FIG. 3B.

The transmitter encodes an input OFDM data bitstream (A) to generate a symbol stream, copies the symbol stream into a plurality of symbol streams which may be identical symbol streams, converts the symbol streams into data complex symbol streams by a predetermined modulation method, converts an input pilot bitstream (P) into a pilot complex symbol stream, and inserts the pilot complex symbol stream into the data complex symbol streams to generate transmission symbol streams. Then, the transmitter performs Fast Fourier Transform (FFT) processing of each of the transmission symbol streams, inserts guard intervals (GIs) into the FFT processed signals, then converts the signals into analog signals, loads the analog signals onto carriers and transmits the signals wirelessly.

The receiver receives a radio wave, extracts an OFDM analog signal from a plurality of allocated channels, converts the analog signal into a digital signal, performs preamble processing of the digital signal to remove a guard interval, performs IFFT processing of the signal to generate a plurality of complex symbol streams, which may be similar complex symbol streams, compensates the symbol streams for distortion, then generates demapping symbol streams, decodes a symbol stream obtained as the average of the demapping symbol streams, and generates the decoded signal in the form of the OFDM data bitstream.

Referring to FIG. 3A, an OFDM transmitting apparatus according to some embodiments of the invention includes an encoding unit 311, a first formatting unit 312, a mapping unit 313, a second formatting unit 314, an FFT unit 315, a GI insertion unit 316, a DA conversion unit 317, and an RF transmission unit 318.

The encoding unit 311 encodes the input OFDM data bitstream and generates the symbol stream. Here, encoding is to prepare data for transmission, such as to code the OFDM data bitstream and to add an error correction code (ECC) by using a Reed Solomon (RS) technique and the like.

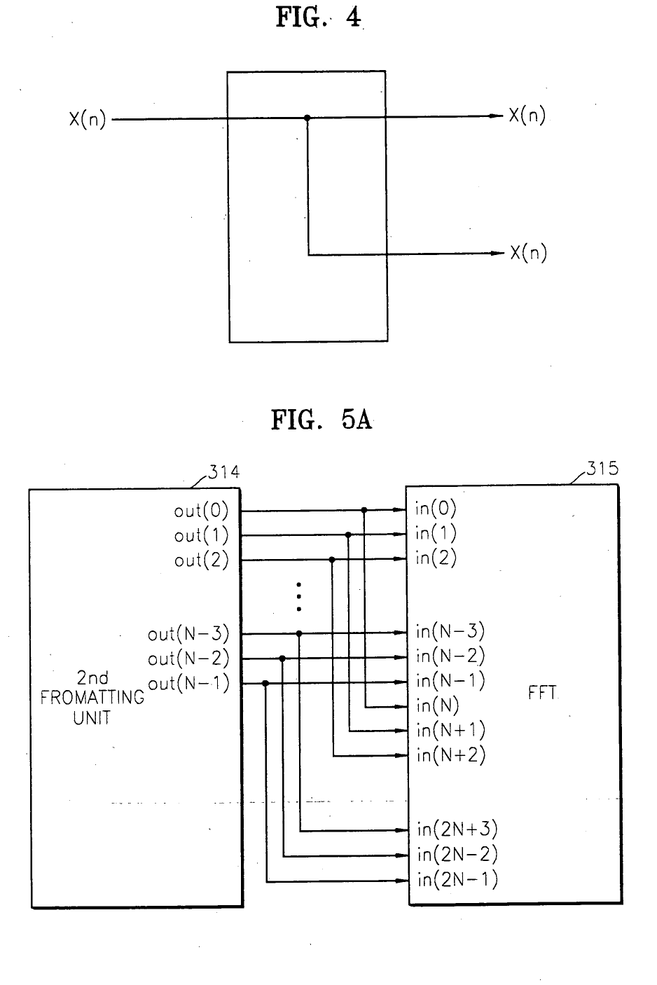

The first formatting unit 312 generates a plurality of copies of the symbol stream, synchronizes the copies of the symbol stream, and outputs the synchronized symbol streams. FIG. 4 is a diagram illustrating signal distribution performed by the first formatting unit 312 of FIG. 3A. Referring to FIG. 4, in some embodiments, the first formatting unit 312 generates a plurality of copies of symbol streams {X(n)s} identical to the input symbol stream {X(n)}, synchronizes the symbol streams to the same clock and outputs the synchronized symbol stream. FIG. 4 shows that the symbol stream {X(n)} is distributed into two identical symbol streams, but depending on a system environment, a symbol stream can be distributed into a plurality of identical symbol streams.

The mapping unit 313 generates data complex symbol streams by converting the respective symbol streams output from the first formatting unit 312 using a predetermined modulation method, and generates a pilot complex symbol stream by converting an input pilot bitstream (P) using the predetermined modulation method. The predetermined modulation method may include binary phase shift keying (BPSK), quadrature phase shift keying (QPSK), quadrature amplitude modulation, and the like, all of which are well known in general telecommunications theory. In particular, Quadrature Amplitude Modulation (QAM) has a variety of modulation methods, such as 16 QAM and 64 QAM, depending on a system environment. In some embodiments, each of the data complex symbol streams and the pilot complex symbol stream modulated by this modulation method is a complex signal formed with an I signal and a Q signal well known in general telecommunications theory.

The second formatting unit 314 generates the transmission symbol streams by inserting the pilot complex symbol stream into each of the data complex symbol stream, arranges the transmission symbol streams in respective points corresponding to the FFT processing, and outputs the transmission symbol streams. Here, arranging the transmission symbol streams in respective points with respect to FFT size can be performed to make the symbol streams arranged in respective points to be loaded on different subcarriers and transmitted, and the pilot complex symbol stream is used for control so that the receiver can perform channel estimation and synchronization.

FIGS. 5A and 5B are diagrams illustrating signal distribution by the second formatting unit 314 of FIG. 3A. FIGS. 5A and 5B show two methods by which, when the FFT size is 2N points, each of the transmission symbol streams are arranged according to the points in the second formatting unit 314. That is, in FIG. 5A, one of the two transmission symbol streams, which are obtained by the duplication, is arranged in 0˜(N−1) points, and the other is arranged in N˜(2N−1) points. Also in FIG. 5B, one of the two transmission symbol streams, which are obtained by the duplication, is arranged in 0˜(N−1) points, and the other can be arranged in (2N−1)˜N points by changing the order.

The FFT unit 315 performs FFT processing on the symbol streams output from the second formatting unit 314 and outputs the results. When the FFT size is 2N points as in FIGS. 5A and 5B, the FFT unit 315 performs FFT processing so that the symbol streams can be transmitted through 2N subchannels.

The GI insertion unit 316 inserts a GI into the signal output from the FFT unit 315 and outputs the results. As known in general telecommunications theory, GI insertion can play a role of preventing interference between symbols of transmission channels.

The DA conversion unit 317 converts the digital signal output from the GI insertion unit 316 into an analog signal and outputs the analog signal. The RF transmission unit 316 loads the analog signal on a subcarrier and wirelessly transmits the subcarrier with the analog signal. When the FFT size is 2N points as in FIGS. 5A and 5B, the RF transmission unit 316 loads the analog signal on 2N subcarriers corresponding to 2N subchannels for wireless transmission.

Referring to FIG. 3B, an OFDM receiver of a wireless LAN according to embodiments of the present invention includes an RF reception unit 321, a DA conversion unit 322, a synchronization unit 323, a GI removing unit 324, an IFFT unit 325, a second deformatting unit 326, an equalizer unit 327, a demapping unit 328, a first deformatting unit 329, a combining unit 330, and a decoding unit 331.

The RF reception unit 321 receives the radio wave, extracts the OFDM analog signal from a plurality of allocated channels, and outputs the extracted OFDM analog signal. When the FFT size is 2N points, as in FIGS. 5A and 5B, the RF reception unit 321 extracts the OFDM analog signal, which is loaded on 2N subcarriers corresponding to two channels or 2N subchannels and then wirelessly transmitted by the RF transmission unit 318, from the radio wave transmitted wirelessly, and outputs the OFDM analog signal. The DA conversion unit 322 converts the OFDM analog signal into a digital signal and outputs the digital signal.

The synchronization unit 323 performs preamble processing which determines the digital signal, performs synchronization and outputs the signal. That is, whether or not the signal is an OFDM signal may be determined based on the preamble of the digital signal arranged in the plurality of channels, and by synchronization processing, the digital signal is synchronized and then output. The GI removing unit 324 removes the GI from the signal output from the synchronization unit 323 and outputs the resulting signal. The IFFT unit 325 performs IFFT processing on the signal output from the GI removing unit 324 and outputs the inverse transformed signal. The IFFT unit 325 corresponding to the FFT unit inversely transforms the signal, and when the FFT size is 2N points as in FIGS. 5A and 5B, has a size of 2N points.

The second deformatting unit 326 outputs the plurality of complex symbol streams corresponding to the plurality of channels, by distinguishing the symbol stream for each point output from the IFFT unit 325 according to the plurality of channels. That is, when the symbol streams are divided into two channels and are arranged in 0˜(N−1) points and N˜(N−1) points as in FIG. 5A, the second deformatting unit 326 divides these symbol streams according to the two channels and outputs two complex symbol streams corresponding to the two channels. Two output complex symbol streams are extracted from the symbol streams copied in the transmitter and are, therefore, similar to each other, and have the shape of a complex signal formed with an I signal and a Q signal.

The equalizer unit 327 compensates the plurality of complex symbol streams for distortion and outputs them. The demapping unit 328 generates and outputs demapping symbol streams from the symbol streams output from the equalizer unit 327. Here, demapping is the inverse process of the process for converting into complex signals performed by the mapping unit and is a process for restoring a complex signal into the original symbol stream. The first deformatting unit 329 synchronizes and outputs the demapping symbol streams.

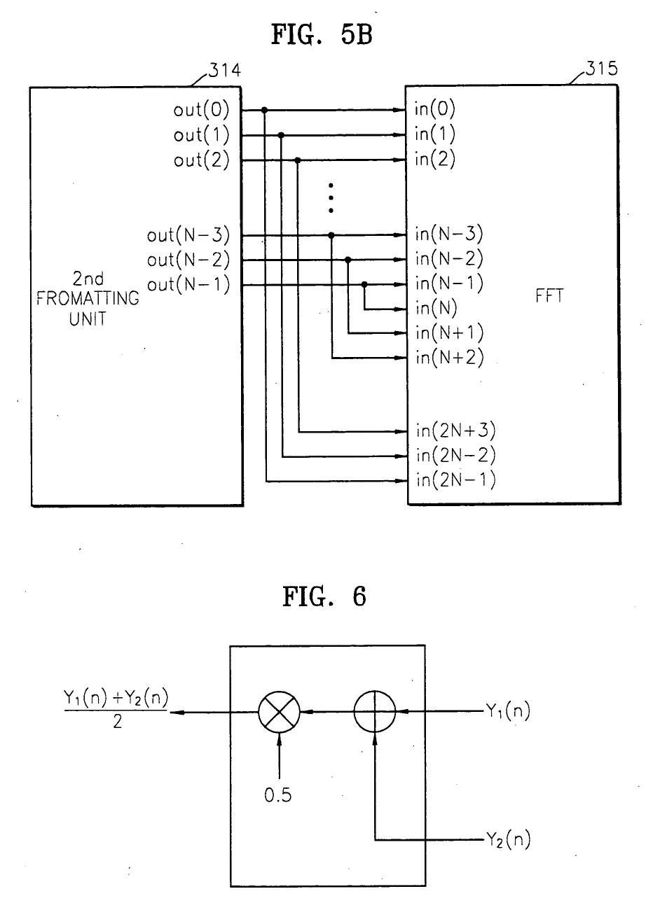

The combining unit 330 takes the average of the demapping symbol streams output from the first deformatting unit 329 and outputs the average. FIG. 6 is a diagram illustrating signal combination of the combining unit 330 of FIG. 3B. Referring to FIG. 6, the two demapping symbol streams {Y1(n), and Y2(n)} which are extracted from the signals loaded on the two channels and transmitted are output from the first deformatting unit 329 and the combining unit 330 takes the average {(Y1(n)+Y2(n))/2} and outputs the average.

The decoding unit 331 decodes the symbol stream output from the combining unit 330 and outputs the decoded symbol stream in the form of the OFDM data bitstream. Here, decoding is to perform error correction, in which an error correction code (ECC) is interpreted by, for example, the RS method and the like, and other processes and output the symbol stream output from the combining unit 330 in the form of the OFDM data bitstream.

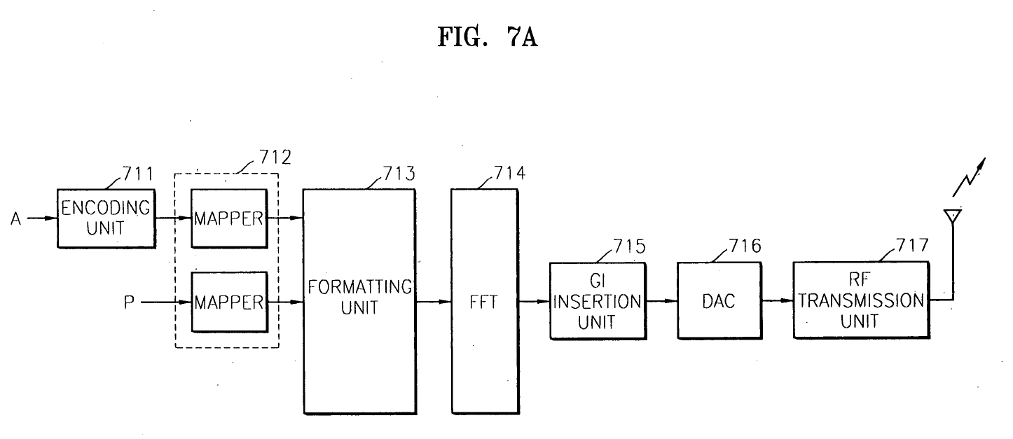

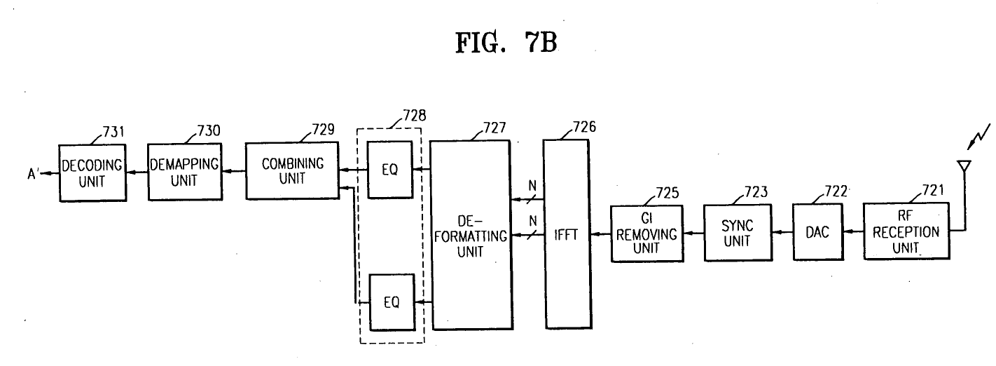

FIGS. 7A and 7B are block diagrams of OFDM transmitting and/or receiving apparatus and methods, for example, in a wireless LAN system, according to other embodiments of the present invention. The OFDM transmitting and/or receiving apparatus comprise a transmitter of FIG. 7A and/or a receiver of FIG. 7B.

The transmitter encodes an input OFDM data bitstream (A) to generate a symbol stream, converts the symbol stream into a data complex symbol stream by a predetermined modulation method, converts an input pilot bitstream (P) into a pilot complex symbol stream, and inserts the pilot complex symbol stream into the data complex symbol stream to generate a transmission symbol stream. Then, the transmitter generates a plurality of symbol stream copies, performs FFT processing of each of the symbol streams, inserts GIs into the FFT processed signals, converts the signals into analog signals, loads onto carriers and transmits the signals wirelessly.

The receiver receives a radio wave, extracts an OFDM analog signal from signals in a plurality of allocated channels, converts the analog signal into a digital signal, performs preamble processing of the digital signal to remove a guard interval, performs IFFT processing of the signals to generate a plurality of complex symbol streams, compensates the plurality of complex symbol streams for distortion, then takes an average to generate a demapping symbol stream, decodes the demapping symbol stream and outputs the signal in the form of the OFDM data bitstream.

Referring to FIG. 7A, an OFDM transmitter according to other embodiments of the present invention includes an encoding unit 711, a mapping unit 712, a formatting unit 713, an FFT unit 714, a GI insertion unit 715, a DA conversion unit 716, and an RF transmission unit 717.

The encoding unit 711 encodes the input OFDM data bitstream and generates the symbol stream. Here, like the encoding unit 311 of FIG. 3A, encoding is to prepare data for transmission, such as to code the OFDM data bitstream and to add an ECC code by using RS techniques and the like.

The mapping unit 712 generates a data complex symbol stream by converting the symbol stream output from the encoding unit 711 using a predetermined modulation method, and generates a pilot complex symbol stream by converting an input pilot bitstream (P) using the predetermined modulation method. As in FIG. 3A, the predetermined modulation method may include binary phase shift keying (BPSK), quadrature phase shift keying (QPSK), quadrature amplitude modulation (QAM), and the like that are known in general telecommunications theory. In particular, the QAM has a variety of modulation methods such as 16 QAM, and 64 QAM, depending on a system environment. Each of the data complex symbol stream and the pilot complex symbol stream modulated by this modulation method is a complex signal formed with an I signal and a Q signal known in general telecommunications theory.

The formatting unit 713 inserts the pilot complex symbol stream into the data complex symbol stream to generate the transmission symbol stream, generates a plurality of symbol stream copies from the transmission symbol stream, and arranges the transmission symbol streams in respective points corresponding to the FFT processing, and outputs the arranged transmission symbol streams. In a similar method as in FIG. 4, the formatting unit 713 generates a plurality of symbol stream copies from the input transmission symbol stream. In a similar method as in FIG. 5A or 5B, when the FFT size is 2N points, the formatting unit 713 arranges one of the two entire transmission symbol streams, which are obtained by the duplication, in 0˜(N−1) points, and the other transmission symbol streams in N˜(2N−1) points. Also in FIG. 5B, one of the two transmission symbol streams, which are obtained by the duplication, is arranged as 0˜(N−1) points, and the other can be arranged as (2N−1)˜N points by changing the order.

The FFT unit 714 performs FFT processing on the symbol streams output from the formatting unit 713 and outputs the results. When the FFT size is 2N points as in FIGS. 5A and 5B, the FFT unit 714 performs FFT processing so that the symbol streams can be transmitted through 2N subchannels.

The GI insertion unit 715 inserts a GI into the signal output from the FFT unit 714 and outputs the results. As known in the general telecommunications theory, GI insertion can play a role of preventing interference between symbols of transmission channels.

The DA conversion unit 716 converts the digital signal output from the GI insertion unit 715 into an analog signal and outputs the analog signal. The RF transmission unit 717 loads the analog signal on a subcarrier and wirelessly transmits the subcarrier and analog signal. When the FFT size is 2N points as in FIGS. 5A and 5B, the RF transmission unit 717 loads the analog signal on 2N subcarriers corresponding to 2N subchannels and wirelessly transmits the subcarrier and analog signal.

Referring to FIG. 7B, OFDM receivers according to other embodiments of the present invention include an RF reception unit 721, a DA conversion unit 722, a synchronization unit 723, a GI removing unit 725, an IFFT unit 726, a deformatting unit 727, an equalizer unit 728, a combining unit 729, a demapping unit 730, and a decoding unit 731.

The RF reception unit 721 receives the radio wave, extracts the OFDM analog signal from a plurality of allocated channels, and outputs the extracted OFDM analog signal. When the FFT size is 2N points as in FIGS. 5A and 5B, the RF reception unit 721 extracts the OFDM analog signal, which is loaded on 2N subcarriers corresponding to 2N subchannels and then wirelessly transmitted by the RF transmission unit 717, from the radio wave transmitted wirelessly, and outputs the OFDM analog signal. The DA conversion unit 722 converts the OFDM analog signal into a digital signal and outputs the digital signal.

The synchronization unit 723 performs preamble processing which determines the digital signal, performs synchronization and outputs the synchronized signal. That is, whether or not the signal is an OFDM signal is determined based on the preamble of the digital signal arranged in the plurality of channels, and by synchronization processing, the digital signal is synchronized and then output. The GI removing unit 725 removes the GI from the signal output from the synchronization unit 723 and outputs the signal. The IFFT unit 726 performs IFFT processing on the signal output from the GI removing unit 725 and outputs the signal. The IFFT unit 726 corresponding to the FFT unit 714 inversely transforms the signal, and when the FFT size is 2N points as in FIGS. 5A and 5B, has a size of 2N points, too.

The deformatting unit 727 outputs the plurality of complex symbol streams corresponding to the plurality of channels, by distinguishing the symbol stream for each point output from the IFFT unit 726 according to the plurality of channels. That is, when the symbol streams are divided into two channels and are arranged in 0˜(N−1) points and N˜(N−1) points as in FIG. 5A, the deformatting unit 727 divides these symbol streams according to the two channels and outputs two complex symbol streams corresponding to the two channels. Two output complex symbol streams are extracted from the symbol streams copied in the transmitter and therefore may be similar to each other, and have the shape of a complex signal formed with an I signal and a Q signal.

The equalizer unit 728 compensates each of the plurality of complex symbol streams for distortion and outputs the compensated complex symbol streams. The combining unit 729 takes the average of the similar complex symbol streams output from the equalizer unit 728, and outputs the average. As in FIG. 6, from the two complex symbol streams which are extracted from the signals loaded on two channels and transmitted, the combining unit 729 obtains and outputs the average (Y1(n)+Y2(n))/2 of the two demapping symbol streams {Y1(n), and Y2(n)} output from the equalizer unit 728.

The demapping unit 730 generates and outputs the demapping symbol stream from the symbol stream output from the combining unit 729. Here, demapping is the inverse process of the process for converting into a complex signal performed by the mapping unit 712 and is a process for restoring a complex signal into the original symbol stream.

The decoding unit 731 decodes the demapping symbol stream and outputs the decoded symbol stream in the form of the OFDM data bitstream. Here, decoding is to perform error correction, in which an error correction code (ECC) is interpreted by, for example, the RS method and the like, and other processes and output the symbol stream output from the demapping unit 730 in the form of the OFDM data bitstream.

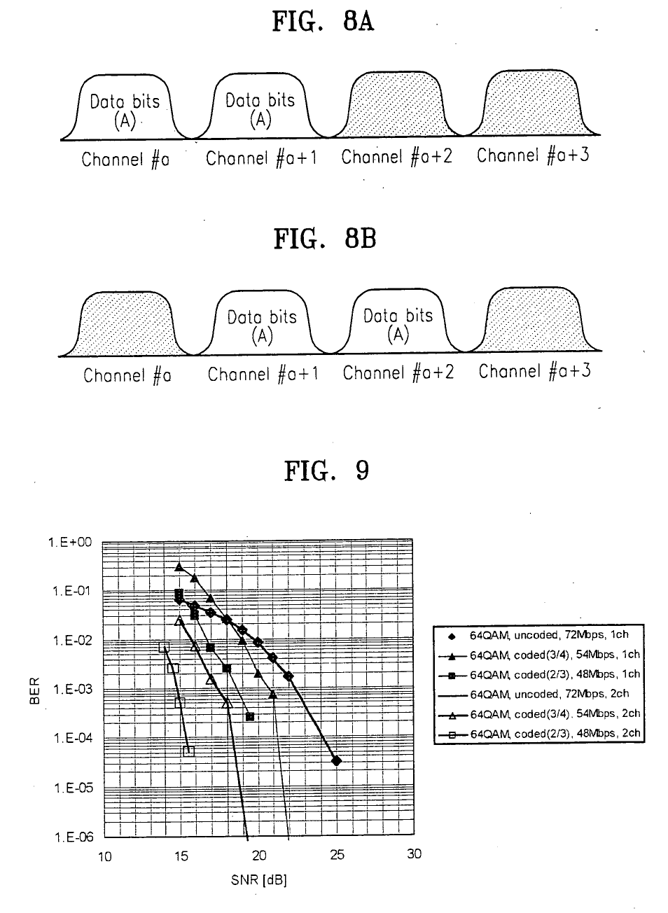

FIGS. 8A and 8B are diagrams illustrating the arrangements of channels allocated to a transmission signal when two channels are used for an identical symbol in an OFDM transmitting and receiving apparatus and methods according to embodiments of the present invention.

Referring to FIGS. 8A and 8B, in OFDM transmitting and/or receiving apparatus and methods according to embodiments of the present invention, when a final OFDM signal converted into an analog signal is loaded on a carrier and wirelessly transmitted by the RF transmission unit 318, 717, two allocated channels are used. The FFT units 315 and 714, which receive each of symbol streams which may have identical values because of the duplication, as in FIGS. 5A and 5B, as the N point size, perform FFT processing so that symbol streams are allocated two channels as in FIGS. 8A and 8B, and each channel is allocated to N subchannels.

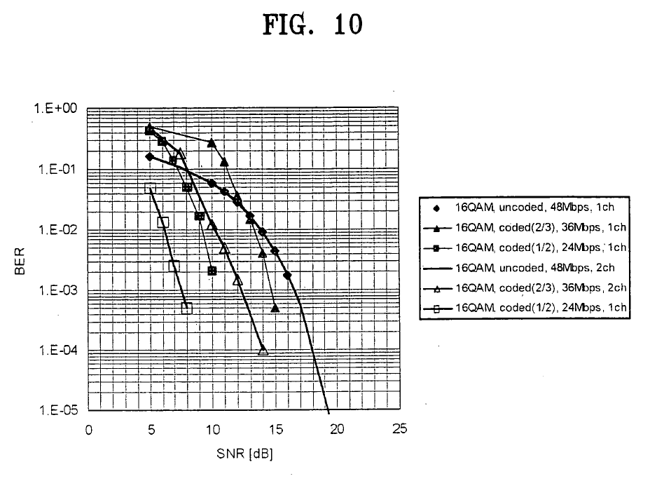

FIG. 9 is a graph showing simulation results of BER values of 64 QAM mapping in an OFDM transmitting and receiving apparatus according to some embodiments of the present invention, and FIG. 10 is a graph showing simulation results of BER values of 16 QAM mapping in an OFDM transmitting and receiving apparatus according to other embodiments of the present invention.

Referring to FIGS. 9 and 10, the results of calculating a BER for an SNR by computer simulation under an additive white Gaussian noise (AWGN) environment for each of 64 QAM mapping and 16 QAM mapping are shown. FIG. 9 shows the results when channel coding was not used (uncoded) and when coding rates were ¾ and ⅔, respectively, and FIG. 10 shows the results when channel coding was not used, and when coding rates were ⅔ and ½, respectively. In FIGS. 9 and 10, as expected based on the telecommunications theory when coding was not used (uncoded), the SNR performance when 1 channel was used is the same as the SNR performance when 2 channels were used. Accordingly, though 2 channels were used, there was no gain in the SNR performance. However, when the methods using channel coding were employed, in both FIGS. 9 and 10, the SNR gain increased with decreasing base BER value, and the SNR gain increased with decreasing coding rate.

The degrees of SNR performance improvement with respect to coding rate when channel coding is used are shown in Table 1. In Table 1, the SNR gains are shown on the basis of a case when BER value is 1E−3. The reason why SNR gains are obtained when channel coding is used though there is no SNR gain when channel coding is not used (uncoded method) is that maximum likelihood of a signal, which is calculated in the process for combining duplicated data transmitted through two channels according to the embodiments of the present invention and in the decoding process by a Viterbi decoder and the like, may be improved.

TABLE 1

| Mapping | Coding rate | 1 channel used | 2 channels used | SNR gain |
|---|---|---|---|---|
| 64 QAM | 3/4 | 20.5 dB | 17.5 dB | 3 dB |
| | 2/3 | 18.5 dB | 14.8 dB | 3.7 dB |
| 16 QAM | 2/3 | 12.5 dB | 12.5 dB | 2 dB |
| | 1/2 | 10.5 dB | 7.5 dB | 3 dB |

As described above, in the OFDM transmitting and/or receiving apparatus and methods according to some embodiments of the present invention, the transmitter encodes an input OFDM data bitstream (A) to generate a symbol stream, copies the symbol stream into a plurality of symbol streams, and converts the symbol streams into data complex symbol streams by a predetermined modulation method, converts an input pilot bitstream (P) into a pilot complex symbol stream, inserts the pilot complex symbol stream into the data complex symbol streams to generate transmission symbol streams. Then, the transmitter performs FFT processing of the transmission symbol streams, inserts GIs into the FFT processed signals, then converts the signals into analog signals, loads onto carriers and transmits the signals wirelessly. The receiver receives a radio wave, extracts an OFDM analog signal from signals in a plurality of allocated channels, converts the analog signal into a digital signal, performs preamble processing of the digital signal to remove a guard interval, performs IFFT processing of the signals to generate a plurality of complex symbol streams, compensates the symbol streams for distortion, then generates demapping symbol streams, decodes a symbol stream obtained as the average of the demapping symbol streams, and generates the decoded signal in the form of the OFDM data bitstream.

As described above, OFDM transmitting and/or receiving apparatus and methods according to some embodiments of the present invention can have an increased SNR gain by duplicated transmission of identical symbols in a plurality of channels. Accordingly, the apparatus may transmit/receive data to/from a longer distance, thereby providing convenience to the users.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. An orthogonal frequency division multiplexing (OFDM) transmitting and receiving apparatus comprising:
a transmitter that is configured to encode an input OFDM data bitstream to generate a symbol stream, copy the symbol stream into a plurality of symbol streams, convert the symbol streams into data complex symbol streams by a predetermined modulation method, convert an input pilot bitstream into a pilot complex symbol stream, insert the pilot complex symbol stream into the data complex symbol streams to generate transmission symbol streams, perform fast Fourier transform (FFT) processing of the transmission symbol streams, insert guard intervals (GIs) into the FFT processed signals, then convert the signals into analog signals, load the analog signals onto carriers corresponding to a plurality of allocated channels and transmits the signals wirelessly; and
a receiver that is configured to receive a radio wave, extract an OFDM analog signal from the plurality of allocated channels, convert the analog signal into a digital signal, perform preamble processing of the digital signal to remove a guard interval, perform inverse fast Fourier transform (IFFT) processing of the signal to generate a plurality of complex symbol streams, compensate the symbol streams for distortion, then generate demapping symbol streams, decode a symbol stream obtained as an average of the demapping symbol streams, and generate the decoded signal as an OFDM data bitstream.

2. The apparatus of claim 1, wherein the transmitter comprises:
an encoding unit that is configured to encode the input OFDM data bitstream and generate the symbol stream;
a first formatting unit that is configured to generate a plurality of copies of symbol streams from the symbol stream, synchronize the copies of symbol streams, and output the copies of symbol streams;
a mapping unit that is configured to generate data complex symbol streams by converting the respective copies of symbol streams output from the first formatting unit by a predetermined modulation method, and generate a pilot complex symbol stream by converting an input pilot bitstream by the predetermined modulation method;
a second formatting unit that is configured to generate the transmission symbol streams by inserting the pilot complex symbol stream into each of the data complex symbol streams, arranging the transmission symbol streams in respective points corresponding to the FFT processing, and outputting the transmission symbol streams;
an FFT unit that is configured to perform FFT processing on the transmission symbol streams output from the second formatting unit;
a GI insertion unit that is configured to insert the GI into the signal output from the FFT unit and output a resulting signal;
a DA conversion unit that is configured to convert the signal output from the GI insertion unit into an analog signal and output the analog signal; and
a radio frequency (RF) transmission unit that is configured to load the analog signal on a subcarrier and wirelessly transmit.

3. The apparatus of claim 1, wherein the receiver comprises:
an RF reception unit that is configured to receive a radio wave, extract the OFDM analog signal from the plurality of allocated channels, and output the OFDM analog signal;
a digital-analog (DA) conversion unit that is configured to convert the OFDM analog signal into a digital signal and output the digital signal;
a synchronization unit that is configured to perform preamble processing, which determines the digital signal, perform synchronization and output a resulting signal;
a GI removing unit that is configured to remove the GI from the signal output from the synchronization unit and output a resulting signal;
an IFFT unit that is configured to perform IFFT processing on the signal output from the GI removing unit and output a resulting signal;
a second deformatting unit that is configured to output the plurality of complex symbol streams corresponding to the plurality of channels, by distinguishing the symbol stream for each point output from the IFFT unit according to the plurality of channels;
an equalizer unit that is configured to compensate each of the plurality of complex symbol streams for distortion and output the complex symbol streams;
a demapping unit that is configured to generate and output demapping symbol streams from the complex symbol streams output from the equalizer unit;
a first deformatting unit that is configured to synchronize and output the demapping symbol streams;
a combining unit that is configured to take the average of the demapping symbol streams output from the first deformatting unit and output the average as a symbol stream; and
a decoding unit that is configured to decode the symbol stream output from the combining unit and output the decoded symbol stream as an OFDM data bitstream.

4. An OFDM transmitting and receiving apparatus comprising:
a transmitter that is configured to encode an input OFDM data bitstream to generate a symbol stream, convert the symbol stream into a data complex symbol stream by a predetermined modulation method, convert an input pilot bitstream into a pilot complex symbol stream, insert the pilot complex symbol stream into the data complex symbol stream to generate a transmission symbol stream, generate a plurality of symbol stream copies, perform FFT processing of the symbol streams copies, insert GIs into the FFT processed signals, convert the GI inserted signals into analog signals, load the analog signals onto carriers and transmit the signals wirelessly; and
a receiver that is configured to receive a radio wave, extract an OFDM analog signal from signals in a plurality of allocated channels, convert the OFDM analog signal into a digital signal, perform preamble processing of the digital signal to remove a guard interval, perform IFFT processing of the signal to generate a plurality of complex symbol streams, compensate each of the plurality of complex symbol streams for distortion, take an average of the compensated plurality of complex symbol streams to generate a demapping symbol stream, decode the demapping symbol stream and output the decoded demapping symbol stream as an OFDM data bitstream.

5. The apparatus of claim 4, wherein the transmitter comprises:
an encoding unit that is configured to encode the input OFDM data bitstream and generate the symbol stream;
a mapping unit that is configured to generate a data complex symbol stream by converting the symbol stream output from the encoding unit by a predetermined modulation method, and generate a pilot complex symbol stream by converting an input pilot bitstream by the predetermined modulation method;
a formatting unit that is configured to insert the pilot complex symbol stream into the data complex symbol stream to generate the transmission symbol stream, generate a plurality of symbol stream copies from the transmission symbol stream, and arrange the transmission symbol streams in respective points corresponding to the FFT processing, and output the transmission symbol streams;
an FFT unit that is configured to perform FFT processing on the transmission symbol streams output from the formatting unit and output a resulting signal;
a GI insertion unit that is configured to insert a GI into the signal output from the FFT unit and output a resulting signal;
a DA conversion unit that is configured to convert the digital signal output from the GI insertion unit into an analog signal and output the analog signal; and
an RF transmission unit that is configured to load the analog signal on a subcarrier and wirelessly transmit the signal.

6. The apparatus of claim 4, wherein the receiver comprises:
an RF reception unit that is configured to receive a radio wave, extract the OFDM analog signal from the plurality of allocated channels, and output the OFDM analog signal;
a DA conversion unit that is configured to convert the OFDM analog signal into a digital signal and output the digital signal;
a synchronization unit that is configured to perform preamble processing, which determines the digital signal, perform synchronization and output a resulting signal;
a GI removing unit that is configured to remove the GI from the signal output from the synchronization unit and output a resulting signal;
an IFFT unit that is configured to perform IFFT processing on the signal output from the GI removing unit and output a resulting signal;
a deformatting unit that is configured to output the plurality of similar complex symbol streams corresponding to the plurality of channels, by distinguishing the symbol stream for each point output from the IFFT unit according to the plurality of channels;
an equalizer unit that is configured to compensate each of the plurality of complex symbol streams for distortion and output the compensated complex symbol streams;
a combining unit that is configured to take the average of the compensated complex symbol streams output from the equalizer unit, and output the average as a symbol stream;
a demapping unit that is configured to generate and output the demapping symbol stream from the symbol stream output from the combining unit; and
a decoding unit that is configured to decode the demapping symbol stream and output the decoded demapping symbol stream as an OFDM data bitstream.

7. An OFDM transmitting method comprising:
encoding an input OFDM data bitstream and generating a symbol stream;
generating a plurality of copies of the symbol stream, synchronizing the copies of the symbol stream, and outputting the synchronized copies of the symbol stream;
generating data complex symbol streams by converting the plurality of copies of the symbol stream, respectively, by a predetermined modulation method, and generating a pilot complex symbol stream by converting an input pilot bitstream by the predetermined modulation method;
generating transmission symbol streams by inserting the pilot complex symbol stream into the data complex symbol streams;
arranging the transmission symbol streams in respective points corresponding to FFT processing;
performing FFT processing on the symbol streams arranged in respective points corresponding to the FFT processing to provide an FFT processed signal;
inserting a GI into the FFT processed signal to provide a digital signal output;
converting the digital signal output into an analog signal;
loading the analog signal on a subcarrier; and
wirelessly transmitting the subcarrier and analog signal.

8. An OFDM receiving method comprising:
receiving a radio wave, extracting an OFDM analog signal from a plurality of allocated channels;
converting the OFDM analog signal into a digital signal;
performing preamble processing which determines the digital signal;
performing synchronization of the determined digital signal to provide a synchronized signal;
removing a GI from the synchronized signal;
performing IFFT processing on the signal, from which the GI is removed;
outputting a plurality of complex symbol streams corresponding to the plurality of channels, by distinguishing the IFFT processed symbol stream for each point according to the plurality of channels;
compensating the plurality of complex symbol streams for distortion;
generating and outputting demapping symbol streams from the symbol streams which are compensated for distortion;
synchronizing and outputting the demapping symbol streams;
taking an average of the synchronized demapping symbol streams to provide an averaged symbol stream;
decoding the averaged symbol stream; and
outputting the decoded averaged symbol stream as an OFDM data bitstream.

9. An OFDM transmitting method comprising:
encoding an input OFDM data bitstream and generating a symbol stream;
generating a data complex symbol stream by converting the symbol stream by a predetermined modulation method, and generating a pilot complex symbol stream by converting an input pilot bitstream by the predetermined modulation method;
inserting the pilot complex symbol stream into the data complex symbol stream to generate a transmission symbol stream;
generating a plurality of symbol stream copies identical to the transmission symbol stream;
arranging the symbol stream copies in respective points corresponding to the FFT processing;
performing FFT processing on the symbol streams which are arranged in respective points corresponding to the FFT processing to provide an FFT processed signal;
inserting a GI into the FFT processed signal to provide a digital signal;
converting the digital signal, in which the GI is inserted, into an analog signal;
loading the analog signal on a subcarrier; and
wirelessly transmitting the subcarrier and the analog signal.

10. An OFDM receiving method comprising:
receiving a radio wave and extracting an OFDM analog signal from a plurality of allocated channels;
converting the OFDM analog signal into a digital signal;
performing preamble processing which determines the digital signal;
performing synchronization of the determined digital signal to provide a synchronized signal;
removing a GI from the synchronized signal;
performing IFFT processing on the signal, in which the GI is removed;
outputting a plurality of complex symbol streams corresponding to the plurality of channels, by distinguishing the IFFT processed symbol stream for each point according to the plurality of channels;
compensating each of the plurality of complex symbol streams for distortion;
taking an average of the complex symbol streams which are compensated for distortion to provide an averaged symbol stream;
generating the demapping symbol stream from the averaged symbol stream;
decoding the demapping symbol stream; and
outputting the decoded demapping symbol stream as an OFDM data bitstream.

11. An Orthogonal Frequency Division Multiplexing (OFDM) transmitting apparatus comprising:
a transmitter that is responsive to an input OFDM data bitstream to generate an OFDM symbol stream and is configured to perform Fast Fourier Transform (FFT) processing on the OFDM symbol stream and to simultaneously transmit the OFDM symbol stream that has been FFT processed over at least two OFDM channels, including OFDM subchannels thereof.

12. An OFDM transmitting apparatus according to claim 11 wherein the transmitter is further configured to copy the OFDM symbol stream and to perform FFT processing on both the OFDM symbol stream and the copied OFDM symbol stream.

13. An Orthogonal Frequency Division Multiplexing (OFDM) receiving apparatus comprising:
a receiver that is configured to simultaneously receive OFDM signals for a single OFDM data bitstream from at least two OFDM channels, including OFDM subchannels thereof, and is further configured to perform Inverse Fast Fourier Transform (IFFT) processing of the single OFDM data bitstream from the at least two OFDM channels to generate at least two OFDM symbol streams for the single OFDM bitstream, and to process the at least two OFDM symbol streams to generate the single OFDM data bitstream.

14. An OFDM receiving apparatus according to claim 13 wherein the receiver is further configured to process the at least two OFDM symbol streams by averaging the at least two OFDM symbol streams.

15. An Orthogonal Frequency Division Multiplexing (OFDM) transmitting method comprising:
generating an OFDM symbol stream from an input OFDM data bitstream;
performing Fast Fourier Transform (FFT) processing on the OFDM symbol stream; and
simultaneously transmitting the OFDM symbol stream that has been FFT processed over at least two OFDM channels, including over a plurality of OFDM subchannels thereof.

16. An OFDM transmitting method according to claim 15 wherein performing FFT processing comprises copying the OFDM symbol stream and performing FFT processing on both the OFDM symbol stream and the copied OFDM symbol stream.

17. An Orthogonal Frequency Division Multiplexing (OFDM) receiving method comprising:
simultaneously receiving OFDM signals for a single OFDM data bitstream from at least two OFDM channels, including OFDM subchannels thereof;
performing Inverse Fast Fourier Transform (IFFT) processing of the single OFDM data bitstream from the at least two OFDM channels to generate at least two OFDM symbol streams for the single OFDM bitstream; and
processing the at least two OFDM symbol streams to generate the single OFDM data bitstream.

18. An OFDM receiving method according to claim 17 wherein the processing comprises averaging the at least two OFDM symbol streams.
